(19) United States
(12) Patent Application Publication
(10) Pub. No.: US 2009/0171758 A1
(43) Pub. Date: Jul. 2, 2009

(54) ARCHITECTURAL DESIGN FOR PHYSICAL INVENTORY APPLICATION SOFTWARE

(76) Inventors: Shai Alfandary, Even Yehuda (IL); Jochen Hirth, Weinheim (DE); Martin J. Wilmes, Oftersheim (DE); Jens Freund, Heidelberg (DE); Gerd Moosmann, Pforzheim (DE)

Correspondence Address: FISH & RICHARDSON, P.C., PO BOX 1022, MINNEAPOLIS, MN, 55440-1022, US

(21) Appl. No.: 11/967,489

(22) Filed: Dec. 31, 2007

(51) Int. Cl. G06Q 10/00; G06F 19/00

(52) U.S. Cl. 705/10; 705/28; 705/29

(57) ABSTRACT

Methods, systems, and apparatus, including computer program products, for implementing a software architecture design for a software application implementing physical inventory. The application is structured as process components such as Accounting process component that records relevant business transactions for valuation and profitability analysis; a Financial Accounting Master Data Management process component that manages financial accounting master data that is used both for accounting and costing purposes; a Physical Inventory Processing process component that manages a process for preparing and executing a physical inventory count, from the preparation, through the actual counting and gathering of count results, to the approval of those results; an Inventory Processing process component that manages inventory and the recording of inventory changes; and a Supply and Demand Matching process component that combines the tasks for ensuring that sufficient material receipt elements exist to cover material demand while taking available capacity into account.

### BACKGROUND

The subject matter of this patent application relates to computer software architecture, and, more particularly, to the architecture of application software for physical inventory.

Enterprise software systems are generally large and complex. Such systems can require many different components, distributed across many different hardware platforms, possibly in several different geographical locations. Thus, the architecture of a large software application, i.e., what its components are and how they fit together, is an important aspect of its design for a successful implementation.

### SUMMARY

This specification presents a software architecture design for a physical inventory software application.

In various aspects, the software architecture design can be implemented as methods, systems, and apparatuses, including computer program products, for implementing a software architecture design for a software application implementing physical inventory. The application is structured as multiple process components interacting with each other through service operations, each implemented for a respective process component. The process components include an Accounting process component, a Physical Inventory Processing process component, an Inventory Processing process component, a Supply and Demand Matching process component, and a Financial Accounting Master Data Management process component.

The subject matter described in this specification can be implemented to realize one or more of the following advantages. Effective use is made of process components as units of software reuse, to provide a design that can be implemented reliably in a cost effective way. Effective use is made of deployment units, each of which is deployable on a separate computer hardware platform independent of every other deployment unit, to provide a scalable design. Service interfaces of the process components define a pair-wise interaction between pairs of process components that are in different deployment units in a scalable way.

Details of one or more implementations of the subject matter described in this specification are set forth in the accompanying drawings and in the description below. Further features, aspects, and advantages of the subject matter will become apparent from the description, the drawings, and the claims.

### BRIEF DESCRIPTION OF THE DRAWINGS

FIG. 1 is a block diagram of a software architectural design for a physical inventory software application.

FIG. 2 illustrates the elements of the architecture as they are drawn in the figures.

FIG. 3 is a block diagram showing interactions between an Inventory Processing process component and a Supply and Demand Matching process component.

FIG. 4 is a block diagram showing interactions between a Physical Inventory Processing process component and a Financial Accounting Master Data Management process component.

FIG. 5 is a block diagram showing interactions between an Inventory Processing process component and a Supply and Demand Matching process component.

FIG. 6 is a block diagram showing interactions between an Inventory Processing process component and an Accounting process component.

FIG. 7 is a block diagram showing interactions of a Physical Inventory Processing process component.

### DETAILED DESCRIPTION

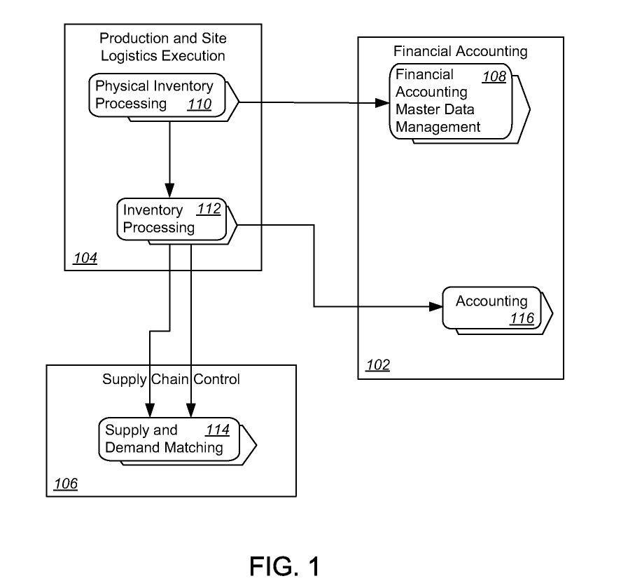

FIG. 1 shows the software architectural design for a physical inventory software application. The physical inventory application is software that implements a preparation and execution of a physical inventory count within a logistics site, from the preparation for a count operation, through the actual counting and gathering of count results, to the approval of those count results and the updating of the site inventory and other systems.

As shown in FIG. 1, the physical inventory design includes three deployment units: a Financial Accounting deployment unit 102, a Production and Site Logistics Execution deployment unit 104, and a Supply Chain Control deployment unit 106.

The Financial Accounting deployment unit 102 includes an Accounting process component 116 that records all relevant business transactions for valuation and profitability analysis, and a Financial Accounting Master Data Management process component 108 that is responsible for the management of financial accounting master data that is used both for accounting and costing purposes.

The Production and Site Logistics Execution deployment unit 104 includes two process components: a Physical Inventory Processing process component 110 and an Inventory Processing process component 112. The Physical Inventory Processing process component 110 manages a process for preparing and executing a physical inventory count, from the preparation, through the actual counting and gathering of count results, to the approval of those results. The Inventory Processing process component 112 manages inventory and the recording of inventory changes. The Inventory Processing process component 112 provides services to maintain current stock, handling unit content, logistics operating unit content and allocation content.

The Supply Chain Control deployment unit 106 includes a Supply and Demand Matching process component 114. The Supply and Demand Matching process component 112 manages all the tasks necessary to ensure that sufficient material receipt elements exist to cover material demand while taking available capacity into account.

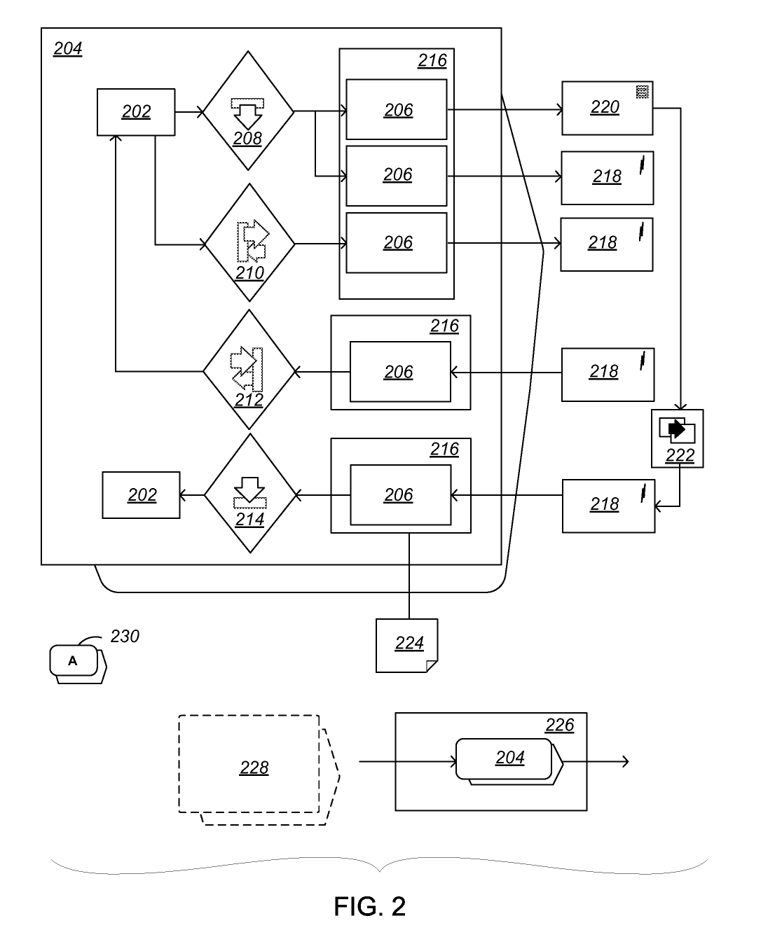

FIG. 2 illustrates the elements of the architecture as they are drawn in the figures of this patent application. The elements of the architecture include the business object 202, the process component 204, the operation 206, the outbound process agent 208, the synchronous outbound process agent 210, the synchronous inbound process agent 212, the inbound process agent 214, the service interface or interface 216, the message 218, the form message 220, the mapping entity 222, the communication channel template 224, and the deployment unit 226.

Not explicitly represented in the figures is a foundation layer that contains all fundamental entities that are used in multiple deployment units 226. These entities can be process components, business objects and reuse service components. A reuse service component is a piece of software that is reused in different transactions. A reuse service component is used by its defined interfaces, which can be, e.g., local APIs (Application Programming Interfaces) or service interfaces.

A process component of an external system is drawn as a dashed-line process component 228. Such a process component 228 represents the external system in describing interactions with the external system; however, the process component 228 need not represent more of the external system than is needed to produce and receive messages as required by the process component that interacts with the external system.

The connector icon 230 is used to simplify the drawing of interactions between process components 204. Interactions between process component pairs 204 involving their respective business objects 202, process agents (at 208, 210, 212, and 214), operations 206, interfaces 216, and messages (at 218 and 22) are described as process component interactions, which determine the interactions of a pair of process components across a deployment unit boundary, i.e., from one deployment unit 226 to another deployment unit 226. Interactions between process components 204 are indicated in FIG. 1 by directed lines (arrows). Interactions between process components within a deployment unit need not be described except to note that they exist, as these interactions are not constrained by the architectural design and can be implemented in any convenient fashion. Interactions between process components that cross a deployment unit boundary will be illustrated by the figures of this patent application; these figures will show the relevant elements associated with potential interaction between two process components 204, but interfaces 216, process agents (at 208, 210, 212, and 214), and business objects 202 that are not relevant to the potential interaction will not be shown.

The architectural design is a specification of a computer software application, and elements of the architectural design can be implemented to realize a software application that implements the end-to-end process mentioned earlier. The elements of the architecture are at times described in this specification as being contained or included in other elements; for example, a process component 204 is described as being contained in a deployment unit 226. It should be understood, however, that such operational inclusion can be realized in a variety of ways and is not limited to a physical inclusion of the entirety of one element in another.

The architectural elements include the business object 202. A business object 202 is a representation of a type of a uniquely identifiable business entity (an object instance) described by a structural model. Processes operate on business objects. This example business object represents a specific view on some well-defined business content. A business object represents content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component 204, is an object that encapsulates transactional data (i.e., data that is valid for a point in time). The term business object will be used generically to refer to a business process object and a master data object, unless the context requires otherwise. Properly implemented, business objects 202 are implemented free of redundancies.

The architectural elements also include the process component 204. A process component 204 is a software package that realizes a business process and generally exposes its functionality as services. The functionality includes the ability to perform all or parts of particular kinds of business transactions. A process component 204 contains one or more semantically related business objects 202. Any business object belongs to no more than one process component. Process components can be categorized as a standard process component, a process component at a business partner, a third party process component, or a user centric process component. The standard process component (named simply process component) is a software package that realizes a business process and exposes its functionality as services. The process component at a business partner is a placeholder for a process component (or other technology that performs the essential functions of the process component) used at a business partner. The third party process component is a process component (or other technology that performs the essential functions of the process component) provided by a third party. The user centric process component is a process component containing user interface parts.

Process components 204 are modular and context-independent. That they are context-independent means that a process component 204 is not specific to any specific application and is reusable. The process component 204 is often the smallest (most granular) element of reuse in the architecture.

The architectural elements also include the operation 206. An operation 206 belongs to exactly one process component 204. A process component 204 generally is able to perform multiple operations 206. Operations 206 can be synchronous or asynchronous, corresponding to synchronous or asynchronous process agents (e.g. at 208, 210, 212, and 214), which will be described below. Operation 206 may be the smallest, separately-callable function, described by a set of data types used as input, output, and fault parameters serving as a signature.

The architectural elements also include the service interface 216, referred to simply as the interface. An interface 216 is a named group of operations 206. Interface 216 typically specifies inbound service interface functionality or outbound service interface functionality. Each operation 206 belongs to exactly one interface 216. An interface 216 belongs to exactly one process component 204. A process component 204 might contain multiple interfaces 216. In some implementations, an interface contains only inbound or outbound operations, but not a mixture of both. One interface can contain both synchronous and asynchronous operations. All operations of the same type (either inbound or outbound) which belong to the same message choreography will belong to the same interface. Thus, generally, all outbound operations 206 directed to the same other process component 204 are in one interface 216.

The architectural elements also include the message 218. Operations 206 transmit and receive messages 218. Any convenient messaging infrastructure can be used. A message is information conveyed from one process component instance to another, with the expectation that activity will ensue. An operation can use multiple message types for inbound, outbound, or error messages. When two process components are in different deployment units, invocation of an operation of one process component by the other process component is accomplished by an operation on the other process component sending a message to the first process component. In some implementations, the message is a form based message 220 that can be translated into a recognized format for an external process component 228. The form message type 220 is a message type used for documents structured in forms. The form message type 220 can be used for printing, faxing, emailing, or other events using documents structured in forms. In some implementations, the form message type 220 provides an extended signature relative to the normal message type. For example, the form message type 220 can include text information in addition to identification information to improve human reading.

The architectural elements also include the process agent (e.g. at 208, 210, 212, and 214). Process agents do business processing that involves the sending or receiving of messages 218. Each operation 206 will generally have at least one associated process agent. The process agent can be associated with one or more operations 206. Process agents (at 208, 210, 212, and 214) can be either inbound or outbound, and either synchronous or asynchronous.

Asynchronous outbound process agents 208 are called after a business object 202 changes, e.g., after a create, update, or delete of a business object instance. Synchronous outbound process agents 210 are generally triggered directly by a business object 202.

An outbound process agent (208 and 210) will generally perform some processing of the data of the business object instance whose change triggered the event. An outbound agent triggers subsequent business process steps by sending messages using well-defined outbound services to another process component, which generally will be in another deployment unit, or to an external system. An outbound process agent is linked to the one business object that triggers the agent, but it is sent not to another business object but rather to another process component. Thus, the outbound process agent can be implemented without knowledge of the exact business object design of the recipient process component.

Inbound process agents (212 and 214) are called after a message has been received. Inbound process agents are used for the inbound part of a message-based communication. An inbound process agent starts the execution of the business process step requested in a message by creating or updating one or multiple business object instances. An inbound process agent is not the agent of a business object but of its process component. An inbound process agent can act on multiple business objects in a process component.

Synchronous agents (210 and 212) are used when a process component requires a more or less immediate response from another process component, and is waiting for that response to continue its work.

Operations and process components are described in this specification in terms of process agents. However, in alternative implementations, process components and operations can be implemented without use of agents by using other conventional techniques to perform the functions described in this specification.

The architectural elements also include the communication channel template. The communication channel template is a modeling entity that represents a set of technical settings used for communication. The technical settings can include details for inbound or outbound processing of a message. The details can be defined in the communication channel template. In particular, the communication channel template defines an adapter type, a transport protocol, and a message protocol. In some implementations, various other parameters may be defined based on a selected adapter type. For example, the communication channel template can define a security level, conversion parameters, default exchange infrastructure parameters, processing parameters, download URI parameters, and specific message properties.

The communication channel template 224 can interact with internal or external process components (at 204 and 228). To interact with an internal process component, the communication channel template is received and uploaded to be used with an operation and interface pair. To interact with an external process component, the communication channel template is received and uploaded to be used with an external entity, such as an external bank, business partner, or supplier.

The architectural elements also include the deployment unit 226. A deployment unit 226 includes one or more process components 204 that are deployed together on a single computer system platform. Conversely, separate deployment units can be deployed on separate physical computing systems. For this reason, a boundary of a deployment unit 226 defines the limits of an application-defined transaction, i.e., a set of actions that have the ACID properties of atomicity, consistency, isolation, and durability. To make use of database manager facilities, the architecture requires that all operations of such a transaction be performed on one physical database; as a consequence, the processes of such a transaction must be performed by the process components 204 of one instance of one deployment unit 226.

The process components 204 of one deployment unit 226 interact with those of another deployment unit 226 using messages 218 passed through one or more data communication networks or other suitable communication channels. Thus, a deployment unit 226 deployed on a platform belonging one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by a deployment unit to be scaled to meet demand by creating as many instances as needed.

Since interaction between deployment units 226 is through service operations, a deployment unit can be replaced by other another deployment unit as long as the new deployment unit supports the operations depended upon by other deployment units. Thus, while deployment units can depend on the external interfaces of process components in other deployment units, deployment units are not dependent on process component interaction within other deployment units. Similarly, process components 204 that interact with other process components 204 or external systems only through messages 218, e.g., as sent and received by operations 206, can also be replaced as long as the replacement supports the operations 206 of the original 204.

In contrast to a deployment unit 226, the foundation layer does not define a limit for application-defined transactions. Deployment units 226 communicate directly with entities in the foundation layer, which communication is typically not message based. The foundation layer is active in every system instance on which the application is deployed. Business objects 202 in the foundation layer will generally be master data objects. In addition, the foundation layer will include some business process objects that are used by multiple deployment units 226. Master data objects and business process objects that should be specific to a deployment unit 226 are assigned to their respective deployment unit 226.

### Interactions Between Process Components “Inventory Processing” and “Supply and Demand Matching”

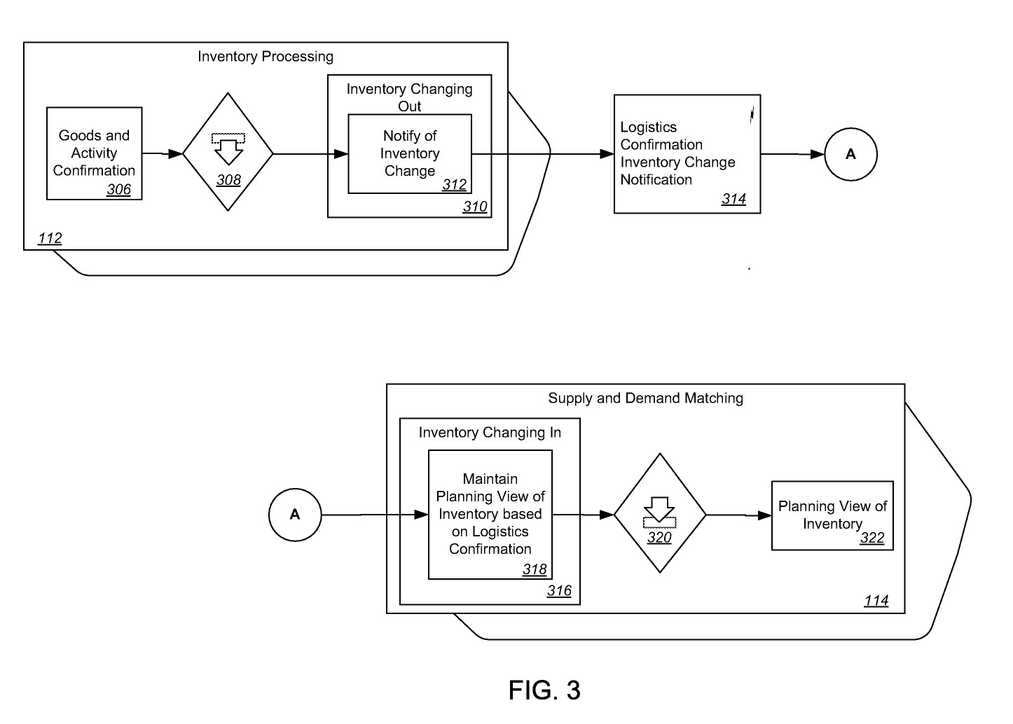

FIG. 3 is a block diagram showing an interaction between the Inventory Processing process component 112 and the Supply and Demand Matching process component 114 in the architectural design of FIG. 1. The Inventory Processing process component 112 updates a planning view of inventory to allow accurate material planning in the Supply and Demand Matching process component 114. The interaction starts when an ad-hoc goods movement is posted.

As shown in FIG. 3, the Inventory Processing process component 112 includes a Goods and Activity Confirmation business object 306. The Goods and Activity Confirmation business object 306 represents a record of confirmed inventory changes that occurred at a specific time.

The Goods and Activity Confirmation business object 306 uses a Notify of Inventory Change from Confirmation to Supply and Demand Matching outbound process agent 308 to invoke a Notify of Inventory Change operation 312. The Notify of Inventory Change operation 312 sends an inventory change planning notification to the Supply and Demand Matching process component 114. The operation 312 is included in an Inventory Changing Out interface 310. The operation 312 generates a Logistics Confirmation Inventory Change Notification message 314.

A Maintain Planning View of Inventory based on Logistics Confirmation operation 318 receives the Logistics Confirmation Inventory Change Notification message 314. The operation 318 is included in an Inventory Changing In interface 316. The operation 318 carries out a relative quantity change to an inventory item disaggregated from actual inventory quantity information that is mapped for a material and certain usability in a supply planning area, in a certain inventory managed location, and for certain identified stock in the Supply and Demand Matching process component 114. The operation 318 uses a Maintain Planning View of Inventory based on Logistics Confirmation inbound process agent 320 to update a Planning View of Inventory business object 322. The Planning View of Inventory business object 322 represents a view of a material stock, aggregated at the level of the Supply Planning Area.

### Interactions Between Process Components “Physical Inventory Processing” and “Financial Accounting Master Data Management”

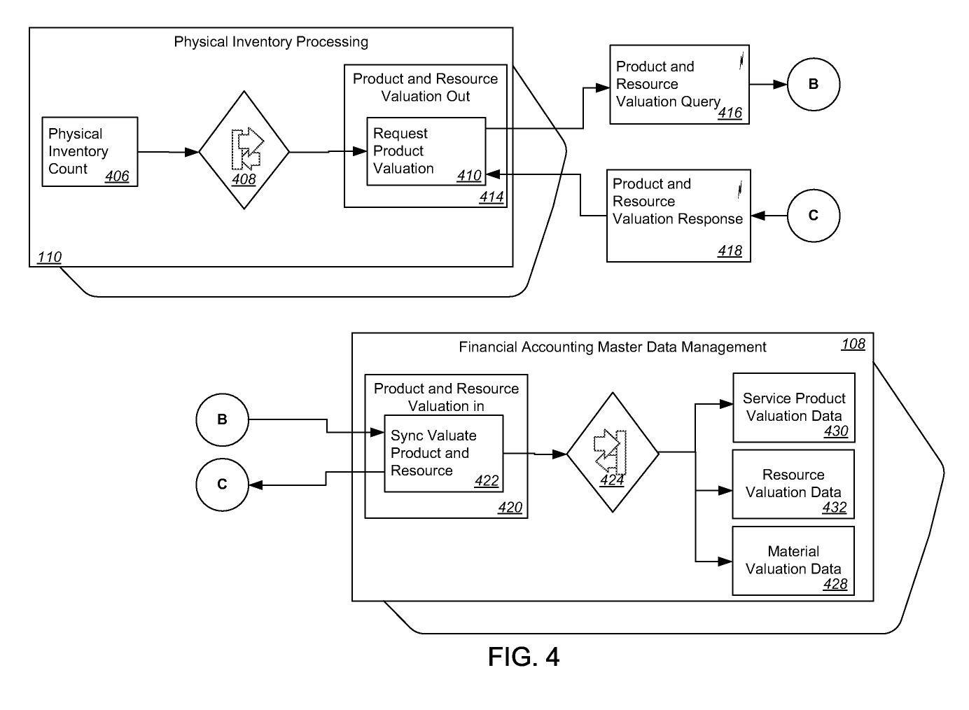

FIG. 4 is a block diagram showing interactions between the Physical Inventory Processing process component 110 and the Financial Accounting Master Data Management process component 108 in the architectural design of FIG. 1. The interaction starts when a sales order is created or changed.

As shown in FIG. 4, the Physical Inventory Processing process component 110 includes a Physical Inventory Count business object 406. The Physical Inventory Count business object 406 represents instructions on how to execute and approve a physical inventory count of materials and packages. In some implementations, a physical inventory count includes the results of the physical inventory and any differences between this physical inventory and the book inventory.

The Physical Inventory Count business object 406 uses a Synchronous Request Product Valuation from Physical Inventory Financial Accounting outbound process agent 408 to invoke a Request Product Valuation operation 410. The Request Product Valuation operation 410 is included in a Product and Resource Valuation Out interface 414. In general, the operation 410 requests a product valuation.

The Request Product Valuation operation 410 sends a Product and Resource Valuation Query message 416 to the Financial Accounting Master Data Management process component 108. The message 416 is received by a Synchronous Valuate Product and Resource operation 422. The operation 422 is included in a Product and Resource Valuation In interface 420. The operation 422 is a synchronous access to price information for products.

The Synchronous Valuate Product and Resource operation 422 uses a Synchronous Valuate and Product Resource inbound process agent 424 to update one or more of three business objects in the Financial Accounting Master Data Management process component 108. The three business objects include a Material Valuation Data business object 428, a Service Product Valuation Data business object 430, and a Resource Valuation Data business object 432. The Material Valuation Data business object 428 includes data that references a material or material group for valuating business transactions, for cost estimates, and for value-based management of material inventories. The Material Valuation Data business object 428 can include the internal valuation prices for a material or material group. The Service Product Valuation Data business object 430 includes data that references a service product or service product group for the valuation of business transactions and for cost estimates and cost accounting. The Service Product Valuation Data business object 430 can include the internal cost rates for a service product or service product group. The Resource Valuation Data business object 432 includes data that references a resource or resource group for the valuation of business transactions and for cost estimates and cost accounting. The Resource Valuation Data business object 432 can include the internal cost rates for a resource or resource group.

In addition to updating the business objects 428, 430, 432, the Synchronous Valuate Product and Resource operation 422 can send a Product and Resource Valuation Response message 418 to update the Physical Inventory Processing process component 110 and respond to the initial Product and Resource Valuation Query message 416.

### Interactions Between Process Components “Inventory Processing” and “Supply and Demand Matching”

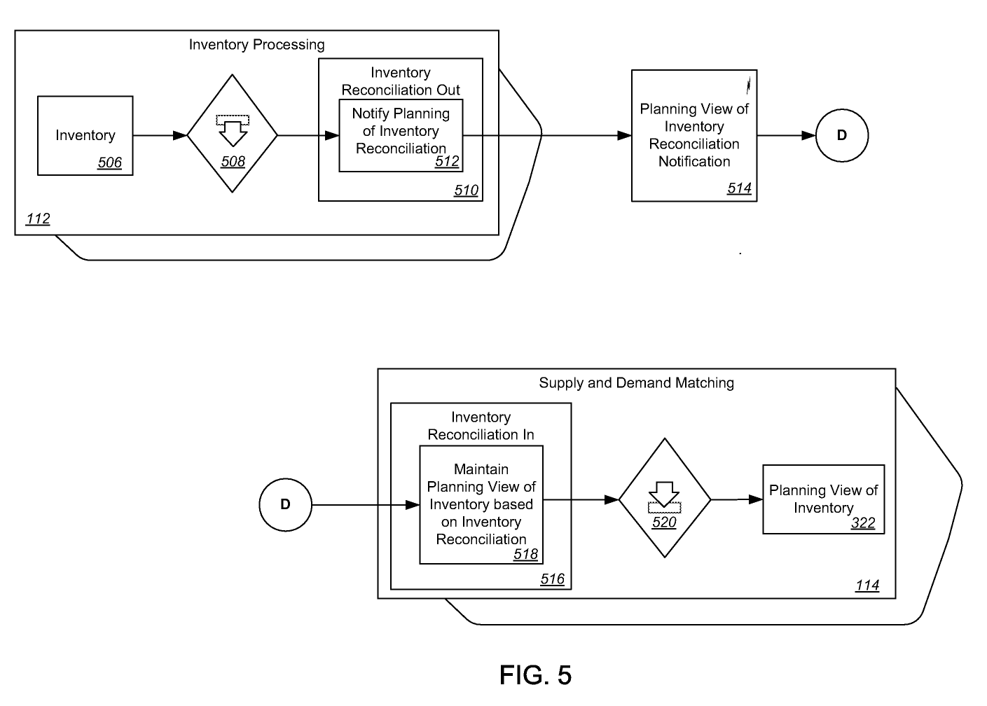

FIG. 5 is a block diagram showing an interaction between the Inventory Processing process component 112 and the Supply and Demand Matching process component 114 in the architectural design of FIG. 1. If a deviation is detected, this interaction can be used to synchronize the available quantities of the Planning View on Inventory business object 322 in the Supply and Demand Matching process component 114 with the available quantities of the original inventory in the Inventory Processing process component 112.

As shown in FIG. 5, the Inventory Processing process component 112 includes an Inventory business object 506. The Inventory business object 506 represents a quantity of all the materials in a location including the material reservations at the location. A request for inventory reconciliation triggers a Notify of Reconciliation from Inventory to Supply and Demand Matching outbound process agent 508. The Notify of Reconciliation from Inventory to Supply and Demand Matching outbound process agent 508 invokes a Notify Planning of Inventory Reconciliation operation 512. The operation 512 notifies the Supply and Demand Matching process component 114 about the reconciliation of inventory quantities aggregated on Material and Supply Planning Area level. The operation 512 is included in an Inventory Reconciliation Out interface 510. The operation 512 uses a Planning View of Inventory Notification message 514 to send the inventory reconciliation update.

The Supply and Demand Matching process component 114 includes an Inventory Reconciliation In interface 516. The Inventory Reconciliation In interface 516 includes a Maintain Planning View of Inventory based on Inventory Reconciliation operation 518. The Maintain Planning View of Inventory based on Inventory Reconciliation operation 518 carries out an absolute quantity update of a stock item disaggregated from actual inventory quantity information that is mapped for a material and certain usability in a supply planning area, in a certain inventory managed location, and for a certain identified stock in the Supply and Demand Matching process component 114. The operation 518 uses a Maintain Planning View of Inventory based on Inventory Reconciliation inbound process agent 520 to update the Planning View of Inventory business object 322. The Planning View of Inventory business object 322 represents a view of material stock, aggregated at the level of the Supply Planning Area.

### Interactions Between Process Components “Inventory Processing” and “Accounting”

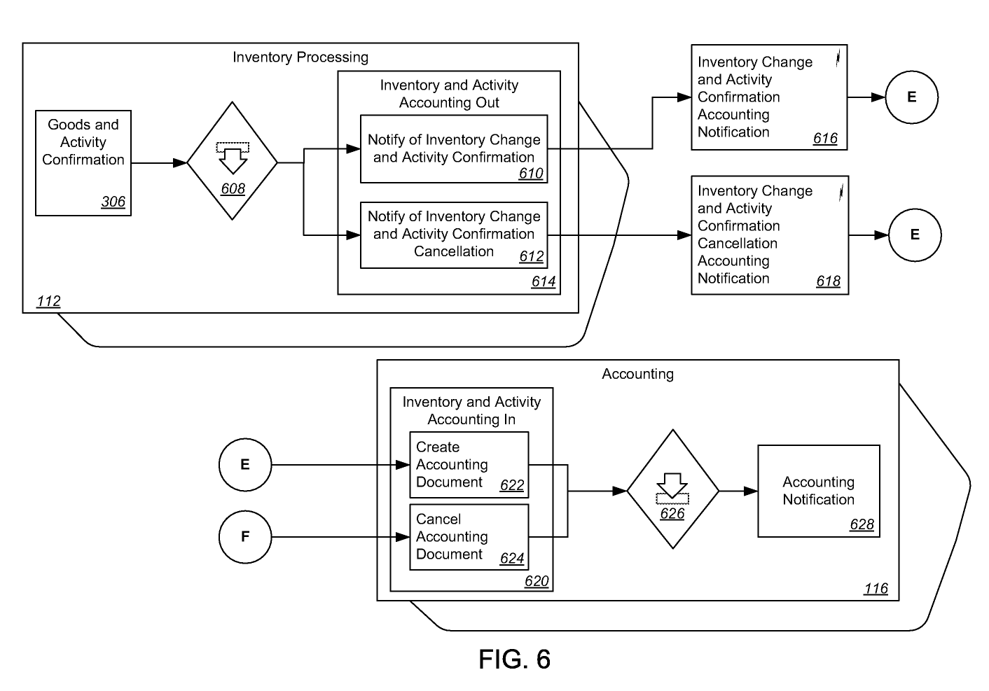

FIG. 6 is a block diagram showing interactions between the Inventory Processing process component 112 and the Accounting process component 116 in the architectural design of FIG. 1. The interaction starts when a goods and activity confirmation is created or cancelled.

As shown in FIG. 6, the Inventory Processing process component 112 includes the Goods and Activity Confirmation business object 306. The Goods and Activity Confirmation business object 306 represents a record of confirmed inventory changes that occurred at a specific time. The Goods and Activity Confirmation business object 306 uses a Notify of Inventory Change from Goods and Activity to Accounting outbound process agent 608 to notify accounting of the existence of an inventory accounting change.

The Notify of Inventory Change from Goods and Activity to Accounting outbound process agent 608 can invoke a Notify of Inventory Change and Activity Confirmation operation 610 or a Notify of Inventory Change and Activity Confirmation Cancellation operation 612. The operations 610 and 612 are included in an Inventory and Activity Accounting Out interface 614. If the Notify of Inventory Change and Activity Confirmation operation 610 is invoked, an Inventory Change and Activity Confirmation Accounting Notification message 616 is sent to the Accounting process component 116. If the Notify of Inventory Change and Activity Confirmation Cancellation operation 612 is invoked, an Inventory Change and Activity Confirmation Cancellation Accounting Notification message 618 is sent to the Accounting process component 116.

A Create Accounting Document operation 622 receives the Inventory Change and Activity Confirmation Accounting Notification message 616. A Cancel Accounting Document operation 624 receives the Inventory Change and Activity Confirmation Cancellation Accounting Notification message 618. The Accounting process component 116 includes an Inventory and Activity Accounting In interface 620. The interface 620 includes the Create Accounting Document operation 622 and the Cancel Accounting Document operation 624. The Create Accounting Document operation 622 receives an inventory change accounting notification about an inventory change if the Inventory Change and Activity Confirmation Accounting Notification message 616 is received. The Cancel Accounting Document operation 624 receives an inventory change accounting cancellation request requesting cancellation of an inventory change if the Inventory Change and Activity Confirmation Cancellation Accounting Notification message 618 is received.

The Accounting process component 116 includes a Maintain Accounting Document Based on Inventory and Activity inbound process agent 626 that can update an accounting document based on inventory changes. After updating the accounting document, the inbound process agent 626 forwards information about the updated document into an Accounting Notification business object 628. The Accounting Notification business object 628 represents a notification sent to Financial Accounting by an operational component regarding a business transaction. The Accounting Notification business object 628 represents this operational business transaction in a standardized form for all business transaction documents and contains the data needed to valuate the business transaction.

### Interactions of Process Component “Physical Inventory Processing”

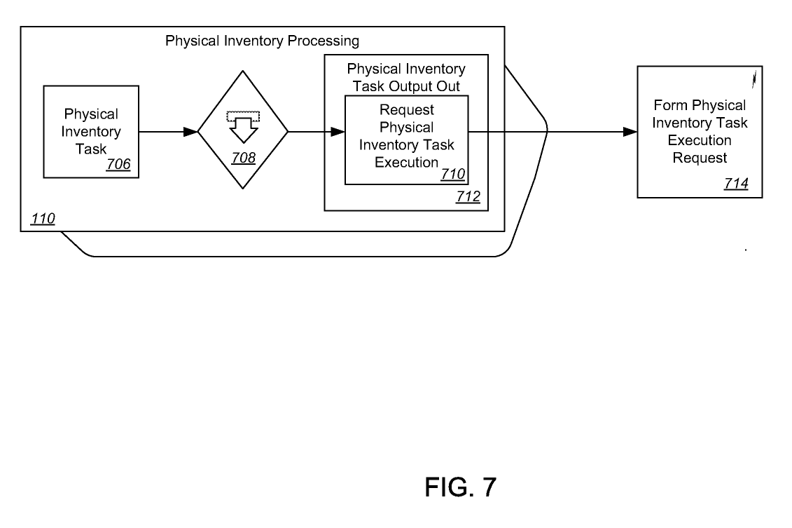

FIG. 7 is a block diagram showing interactions of the Physical Inventory Processing process component 110 in the architectural design of FIG. 1.

As shown in FIG. 7, the Physical Inventory Processing process component 110 includes a Physical Inventory Task business object 706. The Physical Inventory Task business object 706 represents a task for executing a count or count-approval activity of a physical inventory count within a site. The Physical Inventory Task business object 706 can also represent a piece of work to be performed by a person or an automated system.

The Physical Inventory Task business object 706 uses a Request Physical Inventory Task Execution for Output outbound process agent 708 to invoke a Request Physical Inventory Task Execution operation 710. The Request Physical Inventory Task Execution operation 710 is included in a Physical Inventory Task Output Out interface 712. In general, the operation 710 requests the execution of a physical inventory task by generating a Form Physical Inventory Task Execution Request message 716.

The subject matter described in this specification and all of the functional operations described in this specification can be implemented in digital electronic circuitry, or in computer software, firmware, or hardware, including the structural means disclosed in this specification and structural equivalents thereof, or in combinations of them. The subject matter described in this specification can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The subject matter described in this specification can be implemented in a computing system that includes a back-end component (e.g., a data server), a middleware component (e.g., an application server), or a front-end component (e.g., a client computer having a graphical user interface or a Web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the present disclosure or of what may be claimed, but rather as an exemplification of preferred embodiments of the present disclosure. Certain features that are described in this specification in the context of separate embodiments, may also be provided in combination in a single embodiment. Conversely, various features that are described in the context of a single embodiment may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter has been described in terms of particular variations, but other variations can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

What is claimed is:

1. A computer program product comprising application software encoded on a tangible machine-readable information carrier, the application software being structured as process components interacting with each other through service interfaces, the software comprising:
a plurality of process components, each of the process components being a package of software implementing a respective and distinct business process, the plurality of process components including:
an inventory processing process component that manages inventory and the recording of inventory changes;
a physical inventory processing process component that manages a process for preparing and executing a physical inventory count, from the preparation, through the actual counting and gathering of count results, to the approval of those results;
a supply and demand matching process component that combines the tasks for ensuring that sufficient material receipt elements exist to cover material demand while taking available capacity into account for ad-hoc goods movement and for inventory reconciliation; and
an accounting process component that records relevant business transactions for valuation and profitability analysis; and
a plurality of service operations, each service operation being implemented for a respective process component, the operations comprising inbound and outbound operations, the outbound operation for a first process component being operable to send a message to a second process component of the plurality of process components, the second process component having an inbound operation for receiving the message, the passing of messages between an inbound and an outbound operation defining a message-based pair-wise interaction between the respective process components of the respective operations, the pair-wise interactions between pairs of the process components including interactions between:
the inventory processing process component and the accounting process component;
the inventory processing process component and the supply and demand matching process component;
the physical inventory processing process component and the inventory processing process component; and
the physical inventory processing process component and the physical inventory processing component.

2. The product of claim 1, wherein:
the plurality of process components further includes:
a financial accounting master data management process component that is responsible for the management of financial accounting master data that is used both for accounting and costing purposes; and
the pair-wise interactions between pairs of the process components further include interactions between:
the physical inventory processing process component and the financial accounting master data management process component.

3. The product of claim 1, wherein:
each of the plurality of process components is assigned to exactly one deployment unit among multiple deployment units, and each deployment unit is deployable on a separate computer hardware platform independent of every other deployment unit; and
all interaction between a process component in one deployment unit and any other process component in any other deployment unit takes place through the respective service interfaces of the two process components.

4. The product of claim 3, wherein the deployment units comprise:
a financial accounting deployment unit that includes the accounting process component;
a production and site logistics execution deployment unit that includes the physical inventory processing process component and the inventory processing process component; and
a supply chain control deployment unit that includes the supply and demand matching process component.

5. The product of claim 1, wherein:
each of the process components includes one or more business objects; and
none of the business objects of any one of the process components interact directly with any of the business objects included in any of the other process components.

6. The product of claim 5, wherein the business objects comprise a business process object.

7. The product of claim 5, wherein none of the business objects included in any one of the process components is included in any of the other process components.

8. The product of claim 1, further comprising a plurality of process agents, each process agent being either an inbound process agent or an outbound process agent, an inbound process agent being operable to receive a message from an inbound operation, an outbound process agent being operable to cause an outbound operation to send a message, each process agent being associated with exactly one process component.

9. The product of claim 8, wherein the inbound process agents comprise a first inbound process agent operable to start the execution of a business process step requested in a first inbound message by creating or updating one or more business object instances.

10. The product of claim 8, wherein the outbound process agents comprise a first asynchronous outbound process agent that is called after a business object that is associated with the first outbound process agent changes.

11. The product of claim 1, wherein the operations comprise synchronous and asynchronous operations.

12. A system, comprising:
a computer system comprising one or more hardware platforms for executing a computer software application;
a plurality of process components, each of the process components being a package of software implementing a respective and distinct business process, the plurality of process components including:
an inventory processing process component that manages inventory and the recording of inventory changes;
a physical inventory processing process component that manages a process for preparing and executing a physical inventory count, from the preparation, through the actual counting and gathering of count results, to the approval of those results;
a supply and demand matching process component that combines the tasks for ensuring that sufficient material receipt elements exist to cover material demand while taking available capacity into account for ad-hoc goods movement and for inventory reconciliation; and
an accounting process component that records relevant business transactions for valuation and profitability analysis; and
a plurality of service operations, each service operation being implemented for a respective process component, the operations comprising inbound and outbound operations, the outbound operation for a first process component being operable to send a message to a second process component of the plurality of process components, the second process component having an inbound operation for receiving the message, the passing of messages between an inbound and an outbound operation defining a message-based pair-wise interaction between the respective process components of the respective operations, the pair-wise interactions between pairs of the process components including interactions between:
the inventory processing process component and the accounting process component;
the inventory processing process component and the supply and demand matching process component;
the physical inventory processing process component and the inventory processing process component; and
the physical inventory processing process component and the physical inventory processing component.

13. The system of claim 12, wherein:
the plurality of process components further includes:
a financial accounting master data management process component that is responsible for the management of financial accounting master data that is used both for accounting and costing purposes; and
the pair-wise interactions between pairs of the process components include interactions between:
the physical inventory processing process component and the financial accounting master data management process component.

14. The system of claim 12, wherein:
each of the process components includes one or more business objects; and
none of the business objects of any one of the process components interacts directly with any of the business objects included in any of the other process components.

15. The system of claim 12, wherein none of the business objects included in any one of the process components is included in any of the other process components.

16. The system of claim 12, further comprising a plurality of process agents, each process agent being either an inbound process agent or an outbound process agent, an inbound process agent being operable to receive a message from an inbound operation, an outbound process agent being operable to cause an outbound operation to send a message, each process agent being associated with exactly one process component.

17. The system of claim 12, the system comprising multiple hardware platforms, wherein:
the accounting process component and the financial accounting master data management process component are deployed on a first hardware platform;
the physical inventory processing process component and the inventory processing process component are deployed on a second hardware platform; and
the supply and demand matching process component is deployed on a third hardware platform.

18. The system of claim 17, wherein each of the first through the third hardware platforms are distinct and separate from each other.

19. A method for developing a computer software application, comprising:
obtaining in a computer system digital data representing an architectural design for a set of processes implementing an end-to-end application process, the design specifying a process component for each process in the set of processes, the design specifying further specifying a set of process component interactions, wherein:
the specified process components include:
an inventory processing process component that manages inventory and the recording of inventory changes;
a physical inventory processing process component that manages a process for preparing and executing a physical inventory count, from the preparation, through the actual counting and gathering of count results, to the approval of those results;
a supply and demand matching process component that combines the tasks for ensuring that sufficient material receipt elements exist to cover material demand while taking available capacity into account for ad-hoc goods movement and for inventory reconciliation; and
an accounting process component that records relevant business transactions for valuation and profitability analysis; and
the process component interactions include interactions between:
the inventory processing process component and the accounting process component;
the inventory processing process component and the supply and demand matching process component;
the physical inventory processing process component and the physical inventory processing component; and
the physical inventory processing process component and the inventory processing process component; and
using the design including the specified process components and the specified process component interactions to develop a computer software application to perform the set of processes.

20. The method of claim 19, wherein:
the specified process components further include:
a financial accounting master data management process component that is responsible for the management of financial accounting master data that is used both for accounting and costing purposes; and
the process component interactions further include interactions between:
the physical inventory processing process component and the financial accounting master data management process component.

21. The method of claim 19, wherein:
each process in the set of processes is a business process transforming a defined business input into a defined business outcome.

22. The method of claim 21, wherein:
obtaining digital data representing the architectural design further comprises editing the design before using the design.
